(19) United States
(12) Patent Application Publication
(10) Pub. No.: US 2008/0115628 A1
(43) Pub. Date: May 22, 2008

(54) Nut runner system

(75) Inventors: Yoshiaki Shirai, Tokyo (JP); Yasuyuki Tachino, Tokyo (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/983,973

(22) Filed: Nov. 13, 2007

(30) Foreign Application Priority Data
Nov. 20, 2006 (JP) 2006-313050

(51) Int. Cl. B25B 13/48; B23P 19/04

(52) U.S. Cl. 81/55; 29/240

(57) ABSTRACT

A system having a nut runner with a socket and a socket rotation mechanism is disclosed. The system creates a vacuum in the socket using an air vacuum system to attach and retain a bolt in the socket. Further, a high-pressure air blowing system is operated to blow high-pressure air into the socket in order to remove the attached and retained bolt from the socket. The inside of the socket is cleaned simultaneously by the high-pressure air.

### FIELD OF THE INVENTION

The present invention relates to an improvement in a system having a nut runner with a socket and a socket rotation mechanism.

### BACKGROUND OF THE INVENTION

Tools for loosening bolts fastened to a workpiece are broadly classified as manual tools such as spanners, monkey wrenches, and the like, and power tools such as impact wrenches, nut runners, and the like. Power tools have the characteristic of good working efficiency in comparison to manual tools. Therefore, power tools are suited for loosening a large number of bolts in a short time, and in an automobile manufacturing plant, for example, power tools are used for preparation prior to assembly of crankshafts and connection rods (con rods).

In this preparation operation, the con rod is disassembled by unfastening a cap bolt that temporarily joins the rod part of the con rod to a cap, and a lubricant is applied to the internal surface of the con rod bearing. A con rod disassembly fixture provided with an impact wrench whereby the preparation operation can be performed by a single machine is disclosed in Japanese Patent Application Laying-Open Publication No. 2005-144578 (JP 2005-144578 A). This con rod disassembly fixture will be described hereinafter with reference to FIG. 9 hereof.

As shown in FIG. 9, the con rod disassembly fixture 200 is composed of a slide platform 202 provided so as to be able to slide forward and backward (left and right in the drawing) on a base 201; two slide bodies 203, 204 provided on the slide platform 202; two impact wrenches 207, 208 that are each provided so as to be able to slide forward and backward on the slide bodies 203, 204, and that employ a push-starting scheme in which sockets 205, 206 provided to the distal ends of the impact wrenches 207, 208, respectively, receive a prescribed pressure from the front, whereby rotation in the loosening direction is automatically initiated; an adjusting knob 209 attached to the slide platform 202 for adjusting a gap in the vertical direction of the drawing between the impact wrenches 207, 208; and a large-end receiving platform 215 provided on the base 201 for supporting the lower surface of a con rod large end, part 214 of a joint 213 between a piston 211 and a con rod 212 that are positioned by a positioning mechanism not shown in the drawing.

After the joint 213 is positioned, the slide platform 202 is moved forward (to the left in the drawing) by feeding air into a cylinder not shown in the drawing. At the same time, the impact wrenches 207, 208 move forward, and the sockets 205, 206 push against and engage with the heads of connecting bots 216, 217. At this time, the sockets 205, 206 receive a prescribed pressure, whereby the impact wrenches 207, 208 automatically begin to rotate in the loosening direction, and move back (to the right in the drawing) to the extent that the connecting bots 216, 217 are loosened. The rotation of the impact wrenches 207, 208 is automatically stopped when the position is reached at which the fastening of the connecting bots 216, 217 is released. The connecting bots 216, 217 can thus be removed from the con rod large end part 214.

However, the abovementioned impact wrenches 207, 208 have the drawbacks described below.

A first drawback is that it is impossible to confirm whether the sockets 205, 206 are engaged with the connecting bots 216, 217. A bolt may therefore remain unloosened when the bolt loosening operation is performed. Bolts that were missed in the loosening operation must be separately loosened, which increases the work time. Productivity declines as a result.

A second drawback is that the connecting bots 216, 217 remain fitted in the sockets 205, 206 of the impact wrenches 207, 208 after the connecting bots 216, 217 are removed from the con rod large end part 214. In this case, operation of the con rod disassembly fixture 200 must be temporarily stopped in order to manually remove the connecting bots 216, 217 from the sockets 205, 206. Prompt movement to the next loosening operation is therefore impossible. Productivity declines as a result.

A third drawback is that iron powder remains inside the sockets 205, 206 of the impact wrenches 207, 208. When the connecting bots 216, 217 are loosened in this state, since iron powder is present between the internal surfaces of the sockets 205, 206 and the heads of the connecting bots 216, 217, abrasion occurs between the heads of the connecting bots 216, 217 and the internal surfaces of the sockets 205, 206, and the sockets 205, 206 may therefore require more frequent replacement. Replacement part costs therefore increase.

Due to the drawbacks described above, there is a need to develop a bolt-loosening power tool (impact wrenches 207, 208 or a nut runner) whereby productivity can be enhanced, and replacement part costs can be reduced. An object of the present invention is to overcome the abovementioned drawbacks using a nut runner.

### SUMMARY OF THE INVENTION

An object of the present invention is to provide a nut runner system capable of enhancing productivity and minimizing replacement part cost.

According to a first aspect of the present invention, there is provided a nut runner system for unfastening a bolt attached to a workpiece, which comprises a nut runner having a socket for fitting on a head of the bolt, and a socket rotation mechanism for rotating the socket; an air vacuum system for drawing air from within the socket to create a vacuum state within the socket; and a high-pressure air blowing system for blowing air into the socket to create a high-pressure state within the socket; wherein the air vacuum system is operated to attach and retain the bolt on the socket when the head of the bolt is fitted in the socket; and the high-pressure air blowing system is operated to discharge the bolt from the socket using high-pressure air, and an inside of the socket is cleaned by the high-pressure air when the bolt attached to and retained in the socket is removed from the socket.

The air vacuum system and the high-pressure air blowing system are thus connected to the socket in the nut runner system of the present invention. Since the bolt can be attached to and retained in the socket by operating the air vacuum system, the head of the bolt can easily be fitted in the socket. The loosening operation can therefore be smoothly initiated, and productivity can be enhanced using the nut runner system.

Furthermore, the bolt can be discharged from the socket using high-pressure air by operating the high-pressure air blowing system. The bolt can therefore be easily removed from the socket, and loosening of a subsequent bolt can therefore be promptly started. Since wasted work time is thereby eliminated, a nut runner system is provided that has good working efficiency.

In the same manner, the inside of the socket can be cleaned by high-pressure air through the operation of the high-pressure air blowing system. Iron powder can therefore be easily discharged when iron powder remains inside the socket. Since abrasion between the head of the bolt and the internal surface of the socket is thereby reduced, the service life of the socket is extended, and the replacement part cost of the nut runner can be minimized.

The present system is thus capable of enhancing productivity and minimizing replacement part cost.

In a preferred configuration, the bolt is a connecting bolt for temporarily fastening a plurality of the workpieces, and the socket rotation mechanism rotates the temporary fastening bolt in a loosening direction. The workpiece is preferably a split connecting rod that is divided into a rod part and a cap part, and is temporarily fastened by a pair of connecting bolts.

In the operation for unfastening the temporary fastening bolt of the con rod, the temporary fastening bolt must be rapidly removed so that a large number of con rods can be processed in a short time. Therefore, the temporary fastening bolt can be easily loosened through the use of the socket rotation mechanism of the nut runner. Particularly in a split connecting rod, the cap part is provided to the large end part, and the cap part can be disassembled. When this split connecting rod is disassembled, iron powder remains in the socket, and the linkage of the cap part is obstructed when the iron powder escapes and adheres to the large end part. In this regard, since the socket is cleaned by high-pressure air in the present invention, there is no risk of iron powder adhering to the large end part, and the split connecting rod can be satisfactorily joined.

It is preferred in the present invention that the air vacuum system have a vacuum gauge, and that the vacuum gauge measure a vacuum in the socket when the bolt is attached to and retained in the socket. Accordingly, the fitting of the bolt on the socket can be easily confirmed. The bolt loosening operation can therefore be promptly initiated after the bolt is fitted in the socket, and the productivity of the nut runner system can be further enhanced.

It is furthermore preferred in the present invention that the high-pressure air blowing system have a pressure gauge, and that the pressure gauge measure a pressure in the socket when the bolt attached to and retained in the socket is discharged from the socket by high-pressure air. Accordingly, the discharging of the bolt from the socket can be easily confirmed. There is therefore no need for manual confirmation of the presence or absence of the bolt in the socket, and the working efficiency of the nut runner system is enhanced.

According to another aspect of the present invention, there is provided a con rod disassembly device for disassembling a con rod that is divided into a rod part and a cap part, and is temporarily fastened by a pair of connecting bolts, wherein the con rod disassembly device comprises at least one nut runner having a socket for fitting on a head of the bolt, and a socket rotation mechanism for rotating the socket; an air vacuum system for drawing air from within the socket to create a vacuum state within the socket; and a high-pressure air blowing system for blowing air into the socket to create a high-pressure state within the socket; wherein the air vacuum system is operated to attach and retain the bolt on the socket when the head of the bolt is fitted in the socket, and the high-pressure air blowing system is operated to discharge the bolt from the socket using high-pressure air, and an inside of the socket is cleaned by the high-pressure air when the bolt attached to and retained in the socket is removed from the socket.

In other words, during disassembly into the rod part and the cap part of a split connecting rod that is temporarily fastened by a connecting bolt, the connecting bolt is reliably unfastened while loosened by the air vacuum system and the rotation of the socket rotation mechanism, and the bolt attached to and retained in the socket is discharged by the high-pressure air blowing system. The efficiency of the operation for disassembling the split connecting rod is therefore increased.

### BRIEF DESCRIPTION OF THE DRAWINGS

Certain preferred embodiments of the present invention will be described in detail below, by way of example only, with reference to the accompanying drawings, in which:

FIG. 1 is a perspective view showing the nut runner system of the present invention;

FIG. 2 is a sectional view showing the socket and the shaft seal part shown in FIG. 1;

FIG. 3 is a sectional view taken along line 3-3 of FIG. 2;

FIG. 4 is a perspective view showing the con rod disassembly device in which the nut runner system of the present invention is used;

FIG. 5A is a flowchart showing the process from setting of the workpiece to low-speed rotation of the socket;

FIG. 5B is a flowchart showing the process from high-speed rotation of the socket to brushing;

FIG. 6 is a view showing the first warning in the con rod disassembly device;

FIGS. 7A and 7B are views relating to the second warning in the con rod disassembly device;

FIGS. 8A and 8B are views relating to the third warning in the con rod disassembly device; and

FIG. 9 is a plan view showing a conventional con rod disassembly fixture.

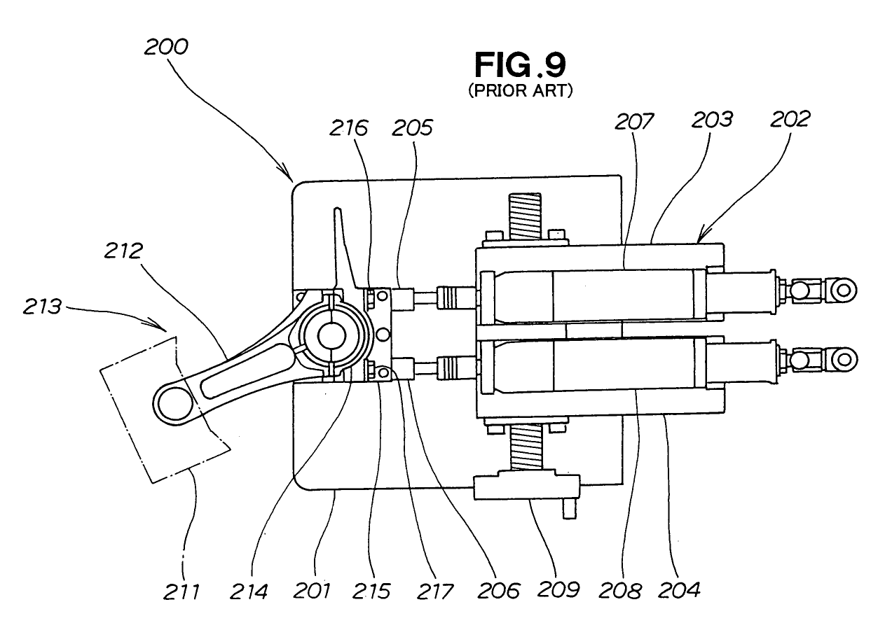

### DESCRIPTION OF THE PREFERRED EMBODIMENTS

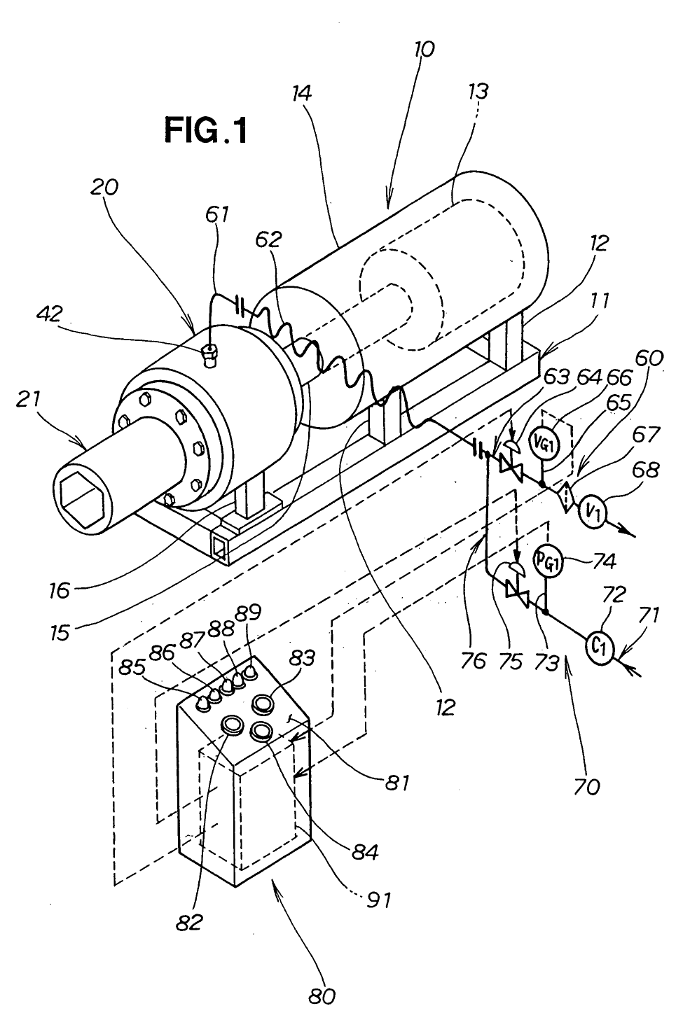

As shown in FIG. 1, the nut runner system is provided with a nut runner 10. The nut runner 10 is a No. 1 bolt loosening tool composed of a socket rotation mechanism 14 that houses a motor 13 and is provided via four (the inner two legs are not shown) legs 12 on a support platform 11; a shaft seal part 20 (described in detail hereinafter) that is attached to an output shaft 15 extending from the socket rotation mechanism 14, and provided via two (the inner leg is not shown) legs 16 on the support platform 11; and a socket 21 that protrudes from the shaft seal part 20.

Since there are two of the nut runner in the con rod disassembly device described hereinafter, the No. 1 nut runner 10 will be described hereinafter as the nut runner.

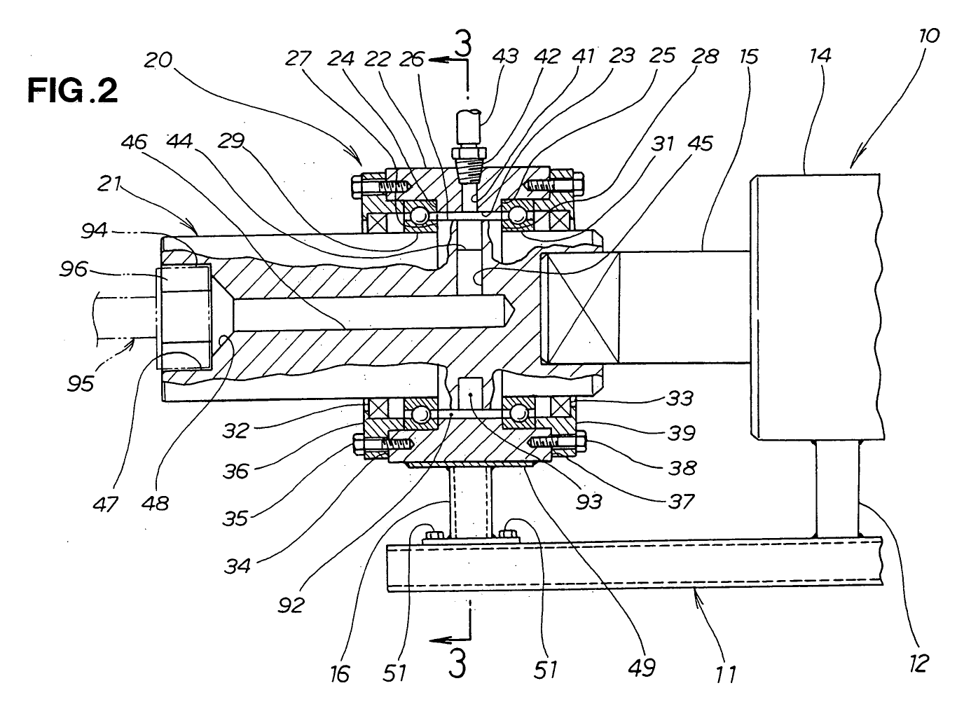

FIG. 2 is a sectional view showing the shaft seal part shown in FIG. 1. The shaft seal part 20 is composed of a static ring 22 formed in a ring shape that is attached to the support platform 11 via the legs 16; a static ring shoulder part 23 formed so as to protrude towards the socket 21 from the internal peripheral surface of the static ring 22; a static ring shoulder front end surface 24 and a static ring shoulder rear end surface 25 formed at the front end and rear end, respectively, of the static ring shoulder part 23; a socket shoulder part 26 formed so as to protrude towards the static ring 22 from the external peripheral surface of the substantial middle part of the socket 21; a socket shoulder front end surface 27 and a socket shoulder rear end surface 28 formed at the front end and rear end, respectively, of the socket shoulder part 26; a first bearing 29 attached between the socket 21 and the static ring 22 and provided so as to push against the static ring shoulder front end surface 24 and the socket shoulder front end surface 27; a second bearing 31 attached between the socket 21 and the static ring 22 and provided so as to push against the static ring shoulder rear end surface 25 and the socket shoulder rear end surface 28; a first tool part 32 and a second tool part 33 that are ring-shaped that separate an arbitrary distance from the first bearing 29 and the second bearing 31 and fit on the external peripheral surface of the socket 21; a first retaining ring 36 that is attached by a plurality of first bolts 35 to the front end surface 34 of the static ring 22 to retain the first bearing 29 and the first tool part 32; and a second retaining ring 39 that is attached by a plurality of second bolts 38 to the rear end surface 37 of the static ring 22 to retain the second bearing 31 and the second tool part 33.

A tapered screw pipe joint 42 is screwed into an air hole 41 formed at the top of the drawing in the static ring 22, and an air conduit 43 is connected to the tapered screw pipe joint 42.

The tapered screw pipe joint 42 may be welded, or may be modified according to another type.

A concave air channel 44 leading from the air hole 41 provided to the static ring 22 is formed through the entire circumference in the center part of the socket shoulder part 26.

Inside the socket 21, a vertical air passage 45 formed so as to extend downward in the drawing from the air channel 44 is provided, a horizontal air passage 46 formed so as to extend to the left in the drawing from the vertical air passage 45 is provided, and a tapered air passage part 48 is also provided that is formed between the horizontal air passage 46 and a bolt head fitting part 47 provided to the front end part of the socket 21. The reference numeral 49 indicates an end plate, and 51 indicates an attachment bolt.

In the socket rotation mechanism 14, the internal motor 13 (FIG. 1) is activated to generate a torque, and the torque is transmitted to the socket 21 via the output shaft 15. The socket 21 can thereby be rotated. The rotation of the socket 21 at this time is smoothly supported by the first bearing 29 and the second bearing 31.

In the nut runner 10 as shown in FIG. 1, a first air vacuum system 60 and a first high-pressure air blowing system 70 for the No. 1 machine are connected to the tapered screw pipe joint 42 provided to the shaft seal part 20, and an independent control panel 80 is also provided for operating the nut runner 10 and controlling the first air vacuum system 60 and the first high-pressure air blowing system 70.

The first air vacuum system 60 is composed of a flanged elbow 61 connected to the tapered screw pipe joint 42; a curved pipe joint 62 connected to the flanged elbow 61; an intake conduit 63 connected to the curved pipe joint 62; a first intake switching valve 64 connected to the intake conduit 63; a first vacuum gauge 66 connected via a branch pipe 65 to the intake conduit 63 that extends from the first intake switching valve 64; and a first oil-sealed rotary vacuum pump 68 provided via a filter 67 to the intake conduit 63 to which the branch pipe 65 is connected.

The first high-pressure air blowing system 70 is composed of a first reciprocating compressor 72 to which a blowing conduit 71 is connected; a first pressure gauge 74 connected via a branch pipe 73 to the blowing conduit 71 that extends from the first reciprocating compressor 72; a first blowing switch valve 75 connected to the blowing conduit 71 to which the branch pipe 73 is connected; and a merging conduit 76 for connecting the first blowing switch valve 75 and the intake conduit 63.

The control panel 80 houses a control unit 91, and is provided with a No. 1 machine operation starting switch 82 on the operating surface 81, a No. 2 machine operation starting switch 83, an operation stopping switch 84, a first warning lamp 85, a No. 1 machine second warning lamp 86, a No. 1 machine third warning lamp 87, a No. 2 machine second warning lamp 88, and a No. 2 machine third warning lamp 89. The control unit 91 controls the first blowing switch valve 75 and the first intake switching valve 64 and monitors the pressure value of the first pressure gauge 74, and the vacuum value of the first vacuum gauge 66.

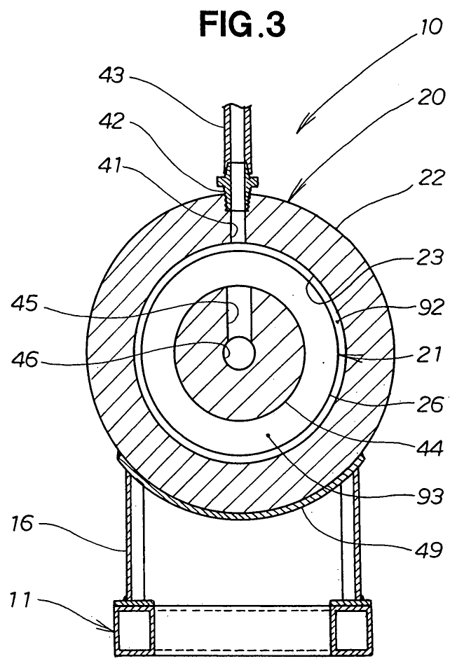

As shown in FIG. 3, a gap 92 is formed along the entire circumference between the static ring shoulder part 23 of the static ring 22 and the socket shoulder part 26 of the socket 21. A peripheral air passage 93 is formed along the entire circumference between the socket shoulder part 26 and the air channel 44.

When the socket 21 is rotating, an airtight seal is maintained in the gap 92 by the first tool part 32 (FIG. 2) and the second tool part 33 (FIG. 2) even when the inside of the shaft seal part 20 is placed in a vacuum state by the first air vacuum system 60 (FIG. 1) or a high-pressure state by the first high-pressure air blowing system 70 (FIG. 1).

The vertical air passage 45 is connected to the horizontal air passage 46. Therefore, when the socket 21 is rotating, the flow of air is not stopped even when the bolt head fitting part 47 (FIG. 2) formed in the socket 21 is in a vacuum state or a high-pressure state.

The operation of the nut runner 10 configured as described above will next be described. The No. 2 machine operation starting switch 83, the No. 2 machine second warning lamp 88, and the No. 2 machine third warning lamp 89 relating to the operation of the No. 2 machine will be described hereinafter.

In FIG. 1, when the socket 21 is fitted in the head 96 (FIG. 2) of the bolt 95, and the No. 1 machine operation starting switch 82 provided to the control panel 80 is turned on, the first intake switching valve 64 opens based on an output signal from the control unit 91. In this open state, air passes through the tapered air passage part 48 (FIG. 2), the horizontal air passage 46 (FIG. 2), the vertical air passage 45 (FIG. 2), the peripheral air passage 93 (FIG. 2), and the air hole 41 (FIG. 2), and is discharged from the first oil-sealed rotary vacuum pump 68 via the curved pipe joint 62 and the intake conduit 63. At this time, a bolt 55 is attached to and retained in the socket 21, and the first blowing switch valve 75 is in a closed state.

Then, after the operation for loosening the bolt 55 is completed, in order to remove the bolt 55 attached to and retained in the socket 21 from the socket 21, the first intake switching valve 64 is placed in the closed state on the basis of the output signal of the control unit 91, and the first blowing switch valve 75 is then placed in the open state on the basis of the output signal from the control unit 91. High-pressure air reaches the head of the bolt through the air hole, the peripheral air passage, the vertical air passage, the horizontal air passage, and the tapered air passage part via the blowing conduit 71, the merging conduit 76, and the curved pipe joint 62 from the first reciprocating compressor 72, and the bolt 55 is discharged from the socket 21.

The inside of the socket 21 is cleaned by allowing the high-pressure air to blow from the socket 21. When operation of the nut runner 10 is thus ended, operation of the nut runner 10 is stopped by pressing the operation stopping switch 84 provided to the control panel 80. The operation described above is repeated to perform a sequence of bolt loosening operations.

Since the first air vacuum system 60 is provided with the first vacuum gauge 66, the strength of the vacuum can be measured when the bolt is attached to and retained in the socket 21. The first high-pressure air blowing system 70 is also provided with the first pressure gauge 74, and the pressure inside the socket 21 can therefore be measured when the bolt is discharged by high-pressure air.

The socket 21 is thus connected to the first air vacuum system 60 and the first high-pressure air blowing system 70. Since the bolt 55 can be attached to and retained in the socket 21 by operating the first air vacuum system 60, the head 56 of the bolt 55 can easily be fitted in the socket 21. The loosening operation can therefore be smoothly initiated, and productivity can be enhanced using the nut runner 10.

Furthermore, the bolt 55 can be discharged using high-pressure air by operating the first high-pressure air blowing system 70. The bolt 55 can therefore be easily removed from the socket 21, and loosening of a subsequent bolt 55 can therefore be promptly started. Since wasted work time is thereby eliminated, a nut runner 10 system is provided that has good working efficiency.

In the same manner, the inside of the socket 21 can be cleaned by high-pressure air through the operation of the first high-pressure air blowing system 70. Iron powder can therefore be easily discharged when iron powder remains inside the socket 21. Since abrasion between the head 56 of the bolt 55 and the internal surface of the socket 21 is thereby reduced, the service life of the socket 21 is extended, and the replacement part cost of the nut runner 10 can be minimized.

In the system of the nut runner 10, the first vacuum gauge 66 is provided to the first air vacuum system 60, and when a bolt is attached to and retained in the socket 21, the strength of the vacuum can be measured. A confirmation can therefore easily be made as to whether the bolt 55 is fitted in the socket. The bolt loosening operation can therefore be promptly initiated after the bolt 55 is fitted in the socket 21, and the productivity of the nut runner 10 can be further enhanced.

The first high-pressure air blowing system 70 is provided with the first pressure gauge 74, and the pressure in the socket 21 can be measured when the bolt 55 is discharged by high-pressure air. The discharging of the bolt 55 from the socket 21 can therefore be easily confirmed. There is therefore no need for manual confirmation of the presence or absence of the bolt 55 in the socket 21, and a nut runner 10 system having even higher working efficiency can be provided.

The nut runner 10 was described using an example in which a single bolt is loosened by a single unit, but in normal factory use, multiple nut runners are built into a device for loosening multiple bolts at once. For example, two nut runners are provided for disassembling con rods as engine parts that are temporarily fastened by bolts.

In the device described below, the bolt 55 is a temporary fastening bolt for a con rod, and a temporary fastening bolt 55 is rotated in the loosening direction by the socket rotation mechanism provided to the nut runner.

The con rod is a split connecting rod. A split connecting rod is a type of con rod in which the circular large end part of the con rod is divided in half.

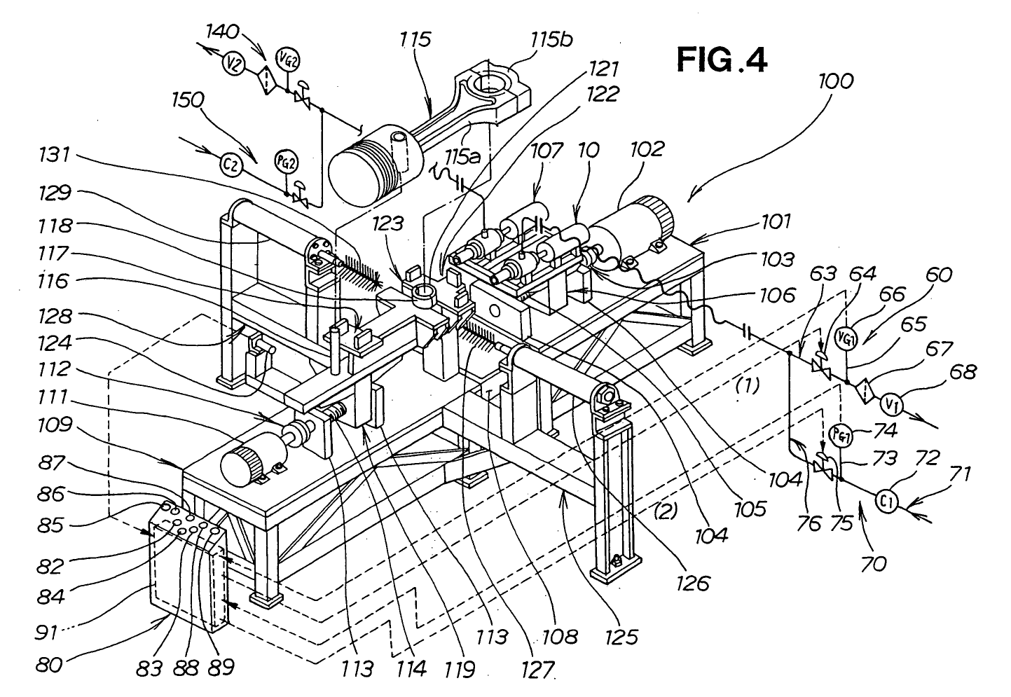

FIG. 4 is a perspective view showing the split connecting rod disassembly device in which the nut runner of the present invention is used. The same reference symbols are used for components that are the same as those in FIG. 1, and no description thereof will be given. “Front,” “rear,” “left,” and “right” mentioned hereinafter refer to directions from the perspective of an operator who is facing the control panel 80.

The con rod disassembly device 100 is composed of a front motor 102 that is attached on a front support platform 101; a front lead screw 105 that is connected to the front motor 102 via a front coupling 103 and is supported by two front fixing panels 104, 104 attached on the front support platform 101; a front moving table 106 that is connected to the front lead screw 105, and can move forward and backward; a nut runner 10 as the No. 1 machine on the right side, and a nut runner 107 as the No. 2 machine on the left side that are provided on the front moving table 106; a rear support platform 109 provided to the front support platform 101 via a bolt recovery platform 108; a rear motor 111 attached on the rear support platform 109; a rear lead screw 114 that is connected to the rear motor 111 via a rear coupling 112, and is supported by two rear fixing panels 113, 113 that are attached on the rear support platform 109; a rear moving table 119 connected to the rear lead screw 114 capable of moving forward and backward that is provided with a large end part retaining half-ring 118, a rod part retainer 117, and a piston retaining rod 116 for supporting a split connecting rod 115; a rear static table 123 attached on the rear support platform 109 so as to made contact with the rear moving table 119, that is provided with a large end part retaining half-ring 121 and a large end part retainer 122; and a workpiece detection sensor 124 in which a proximity sensor, for example, is used that is attached to the rear end of the rear moving table 119.

In the present embodiment, a proximity sensor is used as an example of the workpiece detection sensor 124, but this configuration is not limiting. A limit switch, a touch sensor, or the like, for example, may also be used, or another type of sensor may be used.

A right air cylinder 126 that is supported via a right support member 125 is provided to the right of the rear support platform 109. A right brush 127 is attached to the distal end of the cylinder rod of the right air cylinder 126. A left air cylinder 129 that is supported via a left support member 128 is provided to the left of the rear support platform 109. A left brush 131 is attached to the distal end of the cylinder rod of the left air cylinder 129.

The right air cylinder 126 and the left air cylinder 129 may be hydraulic cylinders, and are not limited to air cylinders.

A second air vacuum system 140 and a second high-pressure air blowing system 150 are connected to the nut runner 107. The second air vacuum system 140 and the second high-pressure air blowing system 150 have the same structure as the first air vacuum system 60 and the first high-pressure air blowing system 70. The structure of the nut runner 107 and the control of the nut runner 107 performed through the control panel 80 are also the same as in the nut runner 10.

The functions of the No. 2 machine operation starting switch 83, the No. 2 machine second warning lamp 88, and the No. 2 machine third warning lamp 89 are the same as the functions of the No. 1 machine operation starting switch 82, the No. 1 machine second warning lamp 86, and the No. 1 machine third warning lamp 87, respectively, and no description thereof will be given. Therefore, only the nut runner 10 will be described below, and the nut runner 107 will not be described.

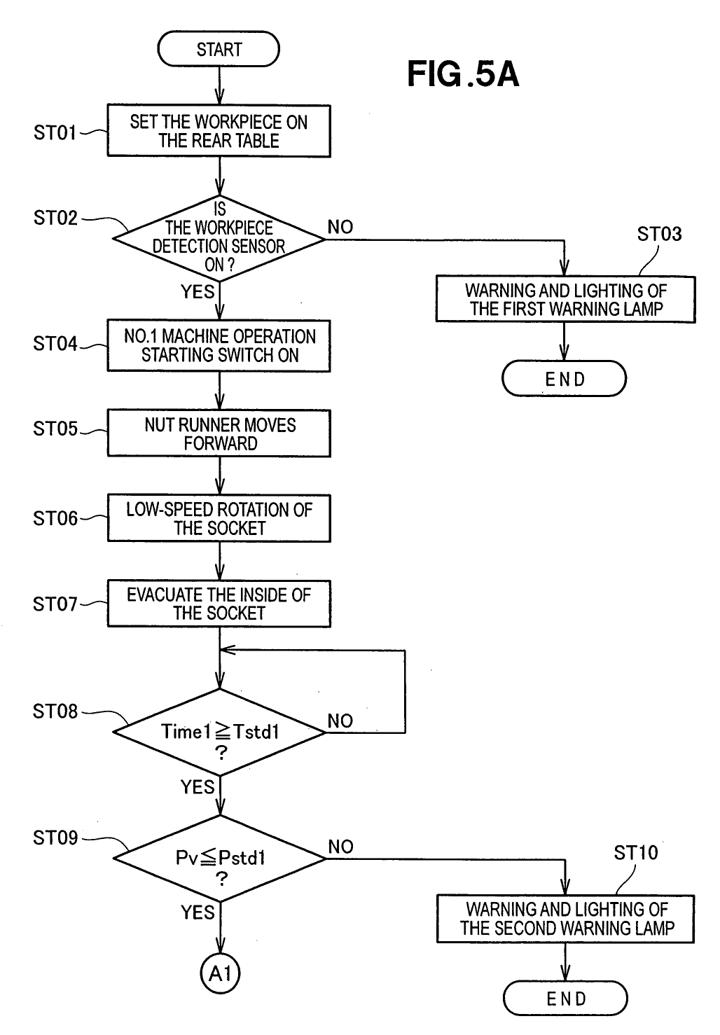

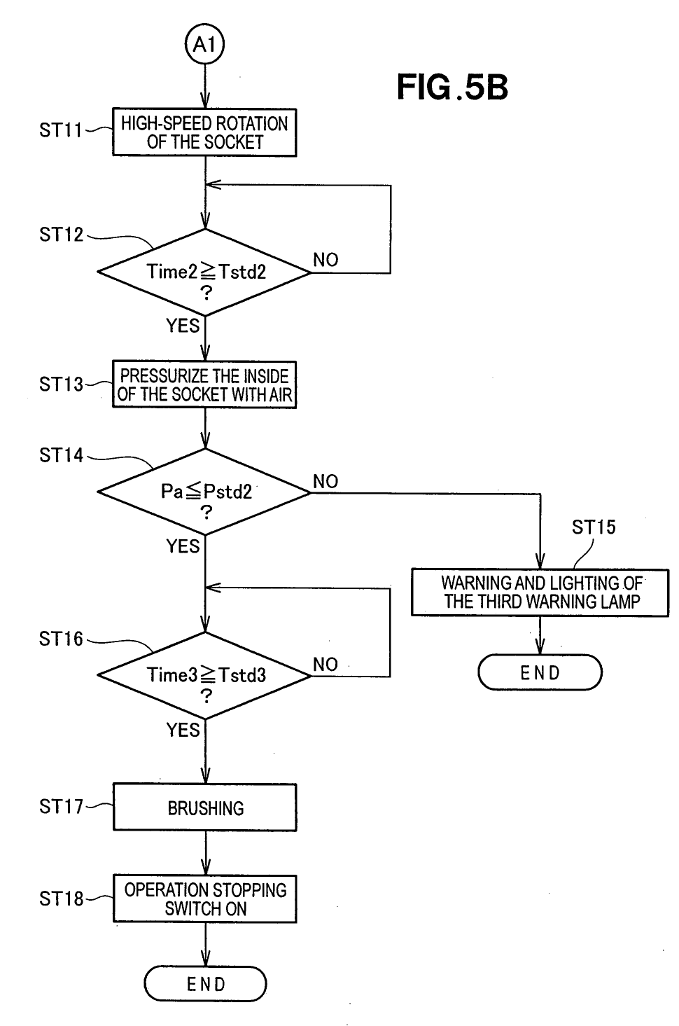

The method for controlling the nut runner 10 shown in FIG. 4 using the control unit 91 will next be described with reference to FIG. 4 and based on the flowcharts shown in FIGS. 5A and 5B. The control flowcharts indicate a case in which the control unit 91 is a programmable logic controller.

FIG. 5A is a flowchart showing the process from setting of the workpiece to low-speed rotation of the socket.

The first oil-sealed rotary vacuum pump 68 and the first reciprocating compressor 72 are always in operation in the following description.

As shown in FIG. 5A, in step (hereinafter abbreviated as ST) 01, the operator sets the workpiece on the rear table. In FIG. 4, the split connecting rod 115 is set on the rear moving table 119 and the rear static table 123.

ST02: A confirmation is made as to whether the workpiece detection sensor 124 is on, and when the result is YES, the process proceeds to ST04. When the result is NO, the process proceeds to ST03. A determination of YES is made when the workpiece detection sensor 124 detects the presence of the split connecting rod 115, and a determination of NO is made when the split connecting rod 115 cannot be detected.

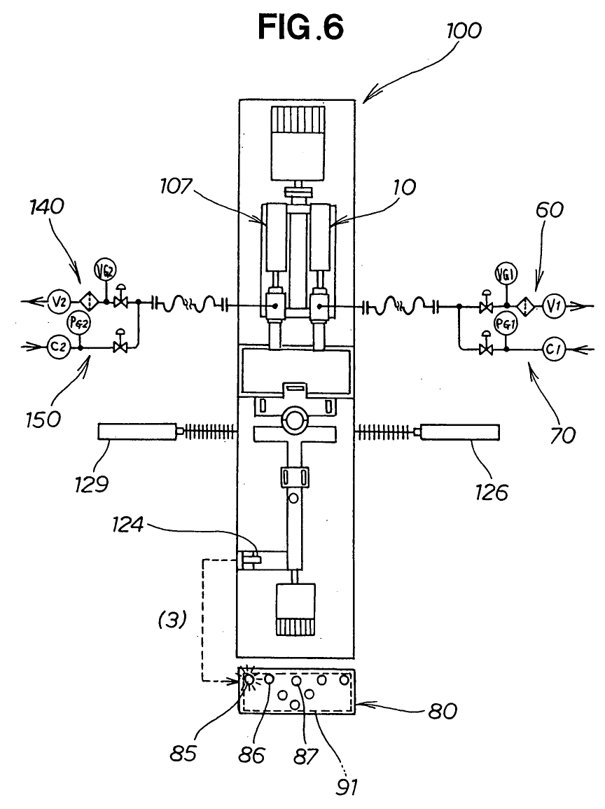

ST03: When the workpiece 115 is not detected by the workpiece detection sensor 124, an alert is sounded, and a warning lamp is lit. In FIG. 4, a first warning signal indicating no detection of a workpiece (a state in which the split connecting rod 115 is not set) is transmitted from the workpiece detection sensor 124 to the control unit 91, whereby the first warning lamp 85 is lit and control is ended (FIG. 6).

ST04: The operator turns on the No. 1 machine operation starting switch 82. When the No. 1 machine operation starting switch 82 is turned on, the control unit 91 performs control to activate the front motor 102.

ST05: The nut runner 10 is thereby moved forward. Specifically, the nut runner 10 is moved forward toward the split connecting rod 115 by the rotation of the front motor 102.

ST06: Low-speed rotation of the socket 21 (FIG. 1) is started at the same time. The control unit 91 performs control to activate the socket rotation mechanism 14 (FIG. 1), and the socket 21 begins low-speed rotation. The socket 21 then begins to fit on the temporary fastening bolt 55 (FIG. 2) of the split connecting rod 115.

ST07: The inside of the socket 21 is evacuated. In FIG. 4, a valve opening signal from the control unit 91 is transmitted to the first intake switching valve 64 as indicated by the dashed line (1), and the first intake switching valve 64 is placed in the open state, whereby a vacuum state is created in the socket 21. The first blowing switch valve 75 is in the closed state at this time.

ST08: A confirmation is made as to whether the counter time Time1 is equal to or above a prescribed time Tstd1, and when the result is YES, the process proceeds to ST09. When the result is NO, the process proceeds to ST08. The prescribed time Tstd1 is an adjustment time for which the allowable range was observed by experience for accurately measuring the vacuum strength.

ST09: A confirmation is made as to whether the pressure Pv inside the socket 21 is equal to or less than a vacuum pressure threshold value Pstd1, and when the result is YES, the process proceeds to ST11. When the result is NO, the process proceeds to ST10.

ST10: When the result is NO in ST09, a warning is issued, the No. 1 machine second warning lamp 86 (FIG. 4) is lit, and control is ended.

FIG. 5B is a flowchart showing the process from high-speed rotation of the socket 21 to brushing.

ST11: The socket 21 is rotated at high speed. The control unit 91 causes the socket 21 to rotate at a high speed, and the socket 21 is rotated in the direction whereby the temporary fastening bolt 55 is loosened. The temporary fastening bolt 55 is loosened, and the rod part 115a (FIG. 4) of the split connecting rod 115 that is mounted on the rear moving table 119 is moved back towards the control panel 80 in a state in which the rod part 115a is attached to and retained in the socket 21. At this time, the cap part 115b (FIG. 4) of the split connecting rod 115 remains mounted on the rear static table 123.

ST12: A confirmation is made as to whether the counter time Time2 is equal to or greater than a prescribed time Tstd2, and when the result is YES, the process proceeds to ST13. When the result is NO, the process returns to the beginning of ST12. The prescribed time Tstd2 is a time obtained by adding an experience-based allowable range to the time from the bolt loosening operation to the bolt extraction operation.

ST13: The inside of the socket 21 is pressurized with air. A valve opening signal from the control unit 91 is transmitted to the first blowing switch valve 75 as indicated by the dashed line (2) in the drawing, and the first blowing switch valve 75 is placed in the open state, whereby high-pressure air from the first reciprocating compressor 72 is fed into the socket 21. The inside of the socket 21 is thereby pressurized with high-pressure air. At this time, the first intake switching valve 64 is in the closed state.

ST14: A confirmation is made as to whether the pressure Pa inside the legs 12 is equal to or less than a pressure threshold value Pstd2, and when the result is YES, the process proceeds to ST16. When the result is NO, the process proceeds to ST15. In other words, when the pressure is equal to or less than the pressure threshold value Pstd2, the bolt 95 is determined to have fallen out of the socket 21. When the pressure is equal to or higher than the pressure threshold value Pstd2, a determination is made that the pressure inside the socket 21 is too high, and the bolt 95 has not been removed from the socket 21. The pressure Pa in the socket 21 is obtained from the first pressure gauge 74, and the pressure signal is inputted to the control unit 91. When the blowing pressure of the first reciprocating compressor 72 is 10 kg/cm²·G, for example, the pressure threshold value Pstd2 is 30% of the blowing pressure, i.e., 3 kg/cm²·G.

ST15: When the result in ST14 is NO, a warning is issued, the No. 1 machine third warning lamp 87 (FIG. 4) is lit, and control is ended. In other words, a pressure equal to or above the pressure threshold value Pstd2 is dangerous, and a warning is issued.

ST16: A confirmation is made as to whether the counter time Time3 is equal to or above a blow time Tstd3, and when the result is YES, the process proceeds to ST17. When the result is NO, the process the process returns to the beginning of ST16. The blow time Tstd3 is approximately 0.5 seconds, for example.

ST17: The surface of the division between the rod part 115a and the cap part 115b of the split connecting rod 115 is brushed. The control unit 91 causes reciprocating operation of the right air cylinder 126 and the left air cylinder 129, and the surface of the division between the rod part 115a and the cap part 115b of the split connecting rod 115 is brushed by the right brush 127 and the left brush 131.

ST18: The operator turns the operation stopping switch on, whereby operation of the con rod disassembly device 100 is stopped.

The control steps described above are described below in terms of operations.

(a) ST01 through ST09 in FIG. 5A constitute the preparation operation.

(b) ST11 and ST12 in FIG. 5B constitute the operation for loosening the temporary fastening bolt 55.

(c) ST13 and ST14 in FIG. 5B constitute the operation for removing the temporary fastening bolt.

(d) ST16 in FIG. 5B is the operation for cleaning out the socket.

(e) ST17 in FIG. 5B is the operation for cleaning the surface of the division between the rod part and the cap part of the split connecting rod 115.

The operation of the con rod disassembly device 100 configured as described above will next be described. The following description is only of the actions of the first warning signal, the second warning signal, and the third warning signal described in steps ST03, ST10, and ST15 above.

FIG. 6 is a diagram showing the action of the first warning signal in the con rod disassembly device.

The first warning lamp 85 is lit when the first warning signal is transmitted from the workpiece detection sensor 124 to the control unit 91 as indicated by the dashed line (3).

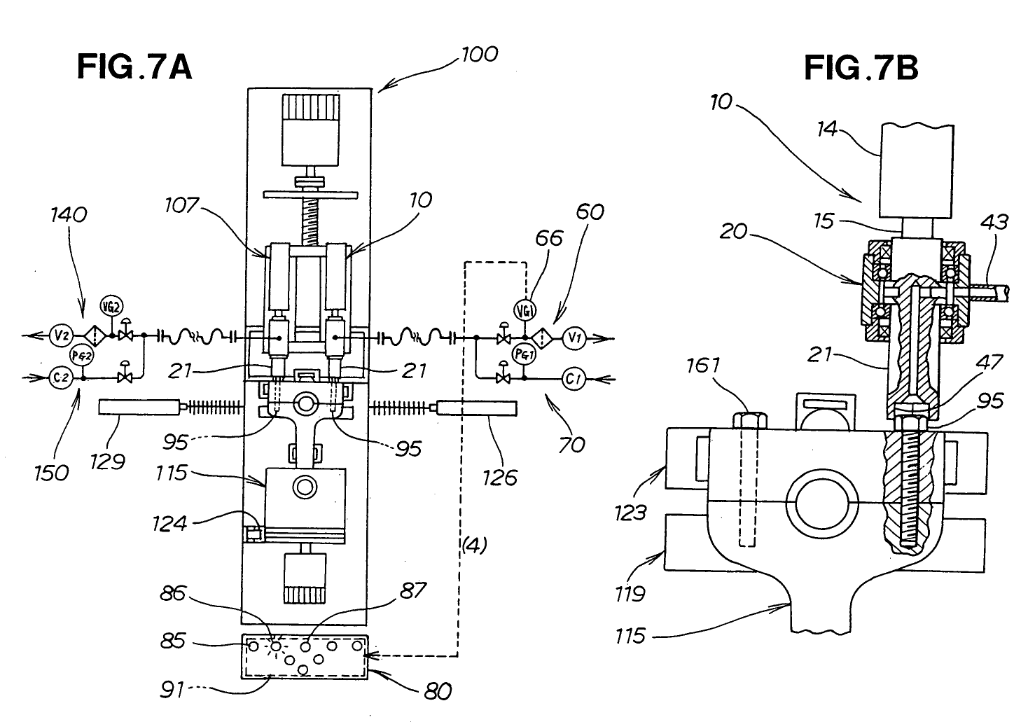

FIGS. 7A and 7B are diagrams showing the action of the second warning signal in the con rod disassembly device.

As shown in FIG. 7A, the second warning lamp 86 is lit when the second warning signal indicating an inadequate vacuum is transmitted from the first vacuum gauge 66 to the control unit 91 as indicated by the dashed line (4).

In this case, as shown in FIG. 7B, the bolt head fitting part 47 of the socket 21 may slip with respect to the temporary fastening bolt 95 by which the split connecting rod 115 is joined, for example.

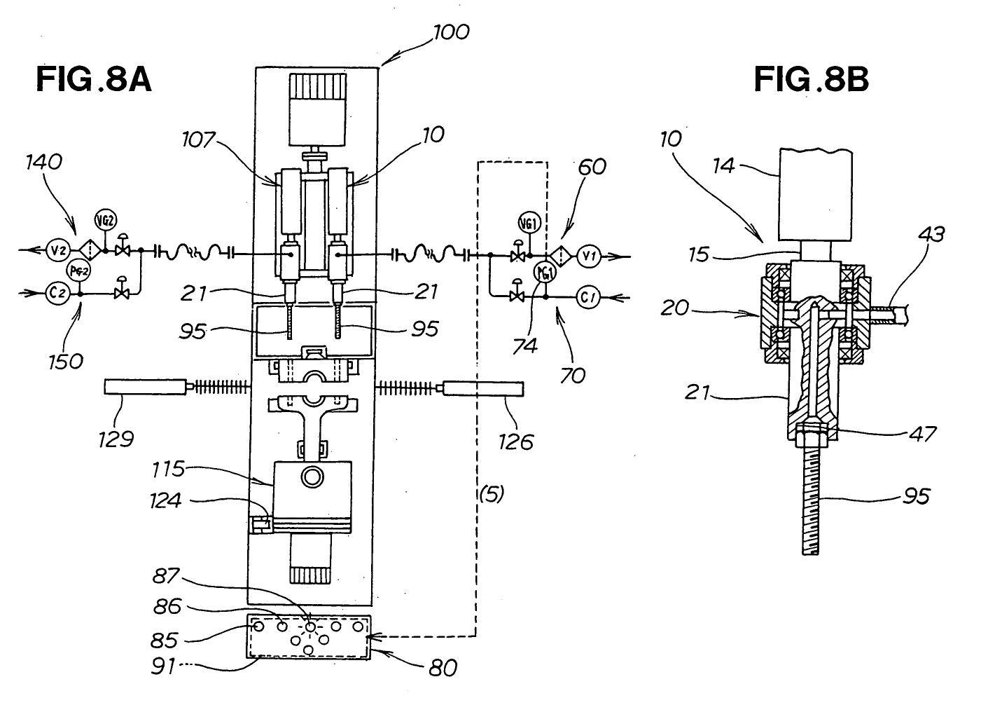

At this time, as shown in FIG. 8A, the third warning lamp 87 is lit when the third warning signal indicating an overpressure is transmitted from the first pressure gauge 74 to the control unit 91 as indicated by the dashed line (5). The lighting of the third warning lamp 87 indicates to the operator that the temporary fastening bolt 95 is not fitted in the socket 21.

The socket rotation mechanism 14 is then rotating at low speed in the loosening direction, and the temporary fastening bolt 95 is therefore fitted in the socket 21 as shown in FIG. 8B.

In the unfastening of temporary fastening bolts 95 of split connecting rods 115 using the con rod disassembly device 100, a large number of split connecting rods 115 are disassembled in a short time (e.g., approximately six connecting rods per minute), and the temporary fastening bolts 95 must therefore be rapidly removed. The temporary fastening bolts 95 can therefore be easily loosened through the use of the socket rotation mechanism 14 provided to the nut runner 10. The nut runner 10 is thus used as the optimum tool for loosening the temporary fastening bolt 95 of a split connecting rod 115.

As described above, the large end part of a split connecting rod 115 is provided with a cap part 115b, and the cap part 115b can be disassembled. During this disassembly, iron powder remains in the socket 21, and the linkage of the cap part 115b is obstructed when the iron powder escapes and adheres to the large end part. In this regard, since the socket 21 is cleaned by high-pressure air in the con rod disassembly device 100 of the present invention, there is no risk of iron powder adhering to the large end part, and the split connecting rod 115 can be satisfactorily joined.

In the present embodiment, an example was described in which an oil-sealed rotary vacuum pump was used as the source of the vacuum in the exhaust system, but the present invention is not limited to this configuration, and another type of vacuum pump such as a reciprocating pump or a Root's-type pump may also be used.

Furthermore, an example was described in the present embodiment in which a reciprocating compressor was used as the source for creating the high-pressure air for the high-pressure air blowing system, but the present invention not limited to this configuration, and a rotary compressor, a centrifugal compressor, an axial compressor, or other type of compressor may also be used.

Obviously, various minor changes and modifications of the present invention are possible in light of the above teaching. It is therefore to be understood that within the scope of the appended claims the invention may be practiced otherwise than as specifically described.

What is claimed is:

1. A nut runner system for unfastening a bolt attached to a workpiece, comprising:
a nut runner having a socket for fitting on a head of the bolt, and a socket rotation mechanism for rotating the socket;
an air vacuum system for drawing air from within the socket to create a vacuum state within the socket; and
a high-pressure air blowing system for blowing air into the socket to create a high-pressure state within the socket,
wherein the air vacuum system is operated to attach and retain the bolt on the socket when the head of the bolt is fitted in the socket, and the high-pressure air blowing system is operated to discharge the bolt from the socket using high-pressure air, and an inside of the socket is cleaned by the high-pressure air when the bolt attached to and retained in the socket is removed from the socket.

2. The system of claim 1, wherein the bolt is a bolt for temporarily fastening a plurality of the workpieces, and the socket rotation mechanism rotates the temporary fastening bolt in a loosening direction.

3. The system of claim 1, wherein the workpiece is a con rod divided into a rod part and a cap part, and is temporarily fastened by a pair of connecting bolts.

4. The system of claim 1, wherein the air vacuum system has a vacuum gauge, and the vacuum gauge measures a vacuum in the socket when the bolt is attached to and retained in the socket.

5. The system of claim 1, wherein the high-pressure air blowing system has a pressure gauge, and the pressure gauge measures a pressure in the socket when the bolt attached to and retained in the socket is discharged from the socket by high-pressure air.

6. A con rod disassembly device for disassembling a con rod that is divided into a rod part and a cap part, and is temporarily fastened by a pair of connecting bolts, the con rod disassembly device comprising:
at least one nut runner having a socket for fitting on a head of the bolt, and a socket rotation mechanism for rotating the socket;
an air vacuum system for drawing air from within the socket to create a vacuum state within the socket; and
a high-pressure air blowing system for blowing air into the socket to create a high-pressure state within the socket,
wherein the air vacuum system is operated to attach and retain the bolt on the socket when the head of the bolt is fitted in the socket, and the high-pressure air blowing system is operated to discharge the bolt from the socket using high-pressure air, and an inside of the socket is cleaned by the high-pressure air when the bolt attached to and retained in the socket is removed from the socket.
